(19) United States
(12) Patent Application Publication
(10) Pub. No.: US 2023/0370798 A1
(43) Pub. Date: Nov. 16, 2023

(54) INFORMATION PROCESSING DEVICE, CONTROL METHOD, NON-TRANSITORY COMPUTER-READABLE MEDIUM, AND INFORMATION PROCESSING SYSTEM

(71) Applicant: NEC Corporation, Minato-ku, Tokyo (JP)

(72) Inventors: Yuji Nakajima, Tokyo (JP); Toshikazu Mauyama, Tokyo (JP); Shizuko Kanegae, Tokyo (JP); Takeomi Muragishi, Tokyo (JP)

(73) Assignee: NEC Corporation, Minato-ku, Tokyo (JP)

(21) Appl. No.: 18/021,899

(22) PCT Filed: Sep. 30, 2020
(86) PCT No.: PCT/JP2020/037184

§ 371 Date: Feb. 17, 2023

(51) Int. Cl. H04S 7/00

(52) U.S. Cl. CPC H04S 7/30

(57) ABSTRACT

An information processing device (1) includes a receiving unit (2) configured to receive, from a user terminal, audio information, position information of the user terminal, direction information of the user terminal, and distance information of a distance from a position indicated by the position information to an installation position to which the audio information is installed virtually. The information processing device (1) further includes a registering unit (3) configured to determine a sound localization position based on the position information, the direction information, and the distance information, and register the first position information, sound localization position information regarding the sound localization position, and the audio information into storage means with the first position information, the sound localization position information, and the audio information mapped to one another.

### TECHNICAL FIELD

The present disclosure relates to information processing devices, control methods, non-transitory computer-readable media, and information processing systems.

### BACKGROUND ART

In one known technique, a user virtually installs audio data to a position that the user specifies, and this virtually installed audio data is output to another user (for example, Patent Literature 1). In another known technique, audio is output from a virtual audio source position, in order to draw a user’s attention to information provided to the user (for example, Patent Literature 2).

Patent Literature 1 discloses an audio reproduction system in which one user selects a position on a map and registers audio data to the selected position and, upon another user reaching the selected position, the registered audio data is reproduced. Patent Literature 2 discloses an audio presentation system that presents a user wearing a wearable terminal with audio corresponding to a position of information provided and an audio source relative position.

### CITATION LIST

### Patent Literature

Patent Literature 1: International Patent Publication No. WO2018/088449
Patent Literature 2: Japanese Unexamined Patent Application Publication No. 2016-021169

### SUMMARY OF INVENTION

### Technical Problem

With sophistication of information communication services, there arises a desire to allow a user to virtually install audio data to a desired position and to provide, to another user present at a predetermined position, audio data subjected to a sound localization process with the aforementioned desired position serving as a sound localization position.

According to the disclosure of Patent Literature 1, audio data is virtually installed and provided to a user present at that position. Even the use of the disclosure of Patent Literature 1, however, may not satisfy the desire described above. Patent Literature 2 is silent as to virtual installation of audio data. Therefore, the use of the disclosure of Patent Literature 2 may not satisfy the desire described above.

In addressing the shortcomings described above, one object of the present disclosure is to provide an information processing device, a control method, a non-transitory computer-readable medium, and an information processing system that each make it possible to output audio information localized to a user’s desired position.

### Solution to Problem

An information processing device according to the present disclosure includes:
receiving means configured to receive, from a first user terminal, audio information, first position information of the first user terminal, first direction information of the first user terminal, and distance information of a distance from a position indicated by the first position information to an installation position to which the audio information is installed virtually; and
registering means configured to determine a sound localization position based on the first position information, the first direction information, and the distance information, and register the first position information, sound localization position information regarding the sound localization position, and the audio information into storage means with the first position information, the sound localization position information, and the audio information mapped to one another.

A control method according to the present disclosure includes:
receiving, from a first user terminal, audio information, first position information of the first user terminal, first direction information of the first user terminal, and distance information of a distance from a position indicated by the first position information to an installation position to which the audio information is installed virtually;
determining a sound localization position based on the first position information, the first direction information, and the distance information; and
registering the first position information, sound localization position information regarding the sound localization position, and the audio information into storage means with the first position information, the sound localization position information, and the audio information mapped to one another.

A non-transitory computer-readable medium according to the present disclosure is a non-transitory computer-readable medium storing a control program that causes a computer to execute the processes of:
receiving, from a first user terminal, audio information, first position information of the first user terminal, first direction information of the first user terminal, and distance information of a distance from a position indicated by the first position information to an installation position to which the audio information is installed virtually;
determining a sound localization position based on the first position information, the first direction information, and the distance information; and
registering the first position information, sound localization position information regarding the sound localization position, and the audio information into storage means with the first position information, the sound localization position information, and the audio information mapped to one another.

An information processing system according to the present disclosure includes:
a first user terminal; and
a server device configured to communicate with the first user terminal, wherein
the first user terminal is configured to acquire audio information, first position information of the first user terminal, first direction information of the first user terminal, and distance information of a distance from a position indicated by the first position information to an installation position to which the audio information is installed virtually, and
the server device is configured to
   receive the audio information, the first position information, the first direction information, and the distance information from the first user terminal, and
   determine a sound localization position based on the first position information, the first direction information, and the distance information, and register the first position information, sound localization position information regarding the sound localization position, and the audio information into storage means with the first position information, the sound localization position information, and the audio information mapped to one another.

### Advantageous Effects of Invention

The present disclosure can provide an information processing device, a control method, a non-transitory computer-readable medium, and an information processing system that each make it possible to output audio information localized to a user’s desired position.

### BRIEF DESCRIPTION OF DRAWINGS

FIG. 1 is a block diagram illustrating a configuration example of an information processing device according to a first example embodiment.

FIG. 2 is a flowchart illustrating an operation example of the information processing device according to the first example embodiment.

FIG. 3 is an illustration for describing an outline of a second example embodiment.

FIG. 4 illustrates a configuration example of an information processing system according to the second example embodiment.

FIG. 5 is a flowchart illustrating an operation example of a server device according to the second example embodiment.

FIG. 6 illustrates a configuration example of an information processing system according to a third example embodiment.

FIG. 7 illustrates a configuration example of an information processing system according to a fourth example embodiment.

FIG. 8 is a flowchart illustrating an operation example of a server device according to the fourth example embodiment.

FIG. 9 illustrates a hardware configuration example of an information processing device and others according to the example embodiments.

### EXAMPLE EMBODIMENT

Hereinafter, some example embodiments of the present disclosure will be described with reference to the drawings. In the following description and drawings, omissions and simplifications are made, as appropriate, to make the description clearer. In the drawings referred to below, identical elements are given identical reference characters, and their repetitive description will be omitted, as necessary.

### First Example Embodiment

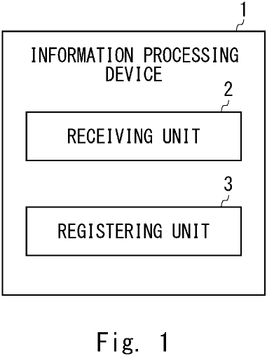

A configuration example of an information processing device 1 according to a first example embodiment will be described with reference to FIG. 1. FIG. 1 is a block diagram illustrating a configuration example of the information processing device according to the first example embodiment. The information processing device 1, for example, is a server device and communicates with a user terminal (not illustrated). The user terminal is a communication terminal used by a user and may be configured to include at least one communication terminal.

The information processing device 1 includes a receiving unit 2 and a registering unit 3.

The receiving unit 2 receives, from the user terminal, audio information, position information of the user terminal, direction information of the user terminal, and distance information of a distance from the position indicated by the position information of the user terminal to an installation position to which the audio information is installed virtually.

The audio information is audio content installed virtually to the installation position. The position information of the user terminal is position information held when the user has made a registration instruction for audio information to indicate that the user is to virtually install the audio information to the installation position. The position indicated by the position information of the user terminal may be different from or the same as the installation position to which the audio information is installed virtually. In other words, the user may virtually install the audio information to a position different from the position where the user is present or may virtually install the audio information to the position where the user is present. The position information of the user terminal may be used as position information of the user. The direction information of the user terminal is direction information held when the user has made a registration instruction for audio information. The direction information of the user terminal may be used as direction information of the user. The direction information of the user terminal may be information that indicates the facial direction that the user’s face is pointing or may be posture information of the user. The direction information of the user terminal includes the orientation that the user’s face is pointing and an elevation angle that indicates the angle formed by a horizontal plane and the direction of the line of sight of the user. Herein, the elevation angle may indicate the angle formed by the ground surface and the direction of the line of sight of the user.

The registering unit 3 determines a sound localization position based on the position information, the direction information, and the distance information. The registering unit 3 identifies the installation position to which audio information is installed virtually based on the position information, the direction information, and the distance information. The registering unit 3 determines the installation position as the sound localization position. In other words, in order to allow the audio information to be installed virtually to a position different from the position where the user is present, the registering unit 3 identifies an installation position where the audio information is to be installed virtually and determines the identified installation position as the sound localization position, with use of the position information, the direction information, and the distance information. The registering unit 3 registers the position information, sound localization position information regarding the sound localization position, and the audio information into a storage unit (not illustrated) with these pieces of information mapped to one another.

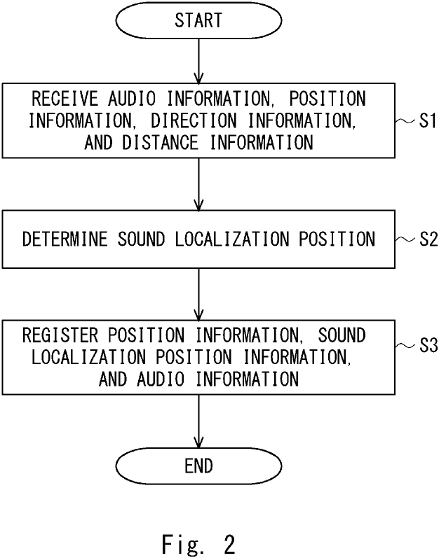

Next, an operation example of the information processing device 1 according to the first example embodiment will be described with reference to FIG. 2. FIG. 2 is a flowchart illustrating an operation example of the information processing device according to the first example embodiment.

The receiving unit 2 receives, from a user terminal, audio information, position information of the user terminal, direction information of the user terminal, and distance information of a distance from the position indicated by the position information of the user terminal to an installation position to which the audio information is installed virtually (step S1).

The registering unit 3 determines a sound localization position based on the position information, the direction information, and the distance information (step S2). The registering unit 3 identifies the installation position to which the audio information is installed virtually based on the position information, the direction information, and the distance information. The registering unit 3 determines the installation position as the sound localization position.

The registering unit 3 registers the position information, sound localization position information regarding the sound localization position, and the audio information into a storage unit (not illustrated) with these pieces of information mapped to one another (step S3).

As described above, the receiving unit 2 receives not only the position information but also the direction information and the distance information, and the registering unit 3 determines the sound localization position based on the position information, the direction information, and the distance information and registers the position information, the sound localization position information, and the audio information with these pieces of information mapped to one another. In this manner, the registering unit 3 determines the sound localization position with use of not only the position information but also the direction information and the distance information, and thus the sound localization position can be set to the user’s desired position. Accordingly, the information processing device 1 according to the first example embodiment can output audio information localized to the user’s desired position.

### Second Example Embodiment

Next, a second example embodiment will be described. The second example embodiment is an example embodiment that embodies the first example embodiment more specifically. Prior to describing a specific configuration example of the second example embodiment, an outline of the second example embodiment will be described.

### <Outline>

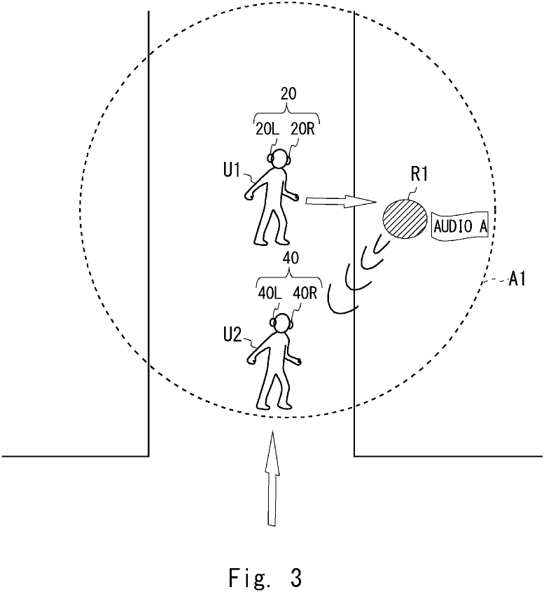

An outline of the second example embodiment will be described with reference to FIG. 3. FIG. 3 is an illustration for describing an outline of the second example embodiment. FIG. 3 schematically illustrates, for example, a situation of road inspection. For example, in a case where a user U1 serving as an inspector inspects a road, the user U1 inspects the road, a side wall on the road, the ceiling of a tunnel, and so on to see whether there is any site that needs repair. If the user U1 finds a site that needs repair R1, the user U1 communicates, to a user U2 serving as a maintenance personnel, the position of the site that needs repair R1 and the condition of the site that needs repair R1. Then, the user U2 finds the site that needs repair R1 and repairs the site that needs repair R1 in accordance with the condition of the site that needs repair R1. Typically, when the user U1 is to communicate the position of the site that needs repair R1 to the user U2, the user U1 records the position of the site that needs repair R1 onto a map and records the condition of the site that needs repair R1 in a memo. The user U2 finds the site that needs repair R1 based on the map that the user U1 has recorded and repairs the site that needs repair R1.

Herein, the user U1 may find a site that needs repair R1, for example, in a side wall on the road. In this case, the user U2 can reach the vicinity of the site that needs repair R1 based on a map that the user U1 has recorded. However, if, for example, the side wall on the road is high, the user U2 may not be able to easily identify where in the side wall the site that needs repair R1 is located with only the map that the user U1 has recorded. In such a case, the user U2 may conceivably find the site that needs repair R1 by looking back and forth at the map and memo that the user U1 has recorded and the side wall. This may take the user U2 some time to find the site that needs repair R1, and, as a result, the user U2 may not be able to repair the site that needs repair R1 as planned.

Accordingly, the present example embodiment achieves a configuration that allows a user U2 to easily find a site that needs repair R1. Specifically, according to the present example embodiment, if a user U1 finds a site that needs repair R1, the user U1 records information that conveys the condition of the site that needs repair R1 or the detailed position of the site that needs repair R1 in the form of audio information (audio A) and virtually installs this audio information to the site that needs repair R1. Then, when a user U2 has arrived at the vicinity of the site that needs repair R1, the audio information whose acoustic image is localized to the position of the site that needs repair R1 is output to the user U2. With this configuration, the user U2 can easily identify the position of the site that needs repair R1 to which the audio information (audio A) is virtually installed, as the user U2 moves to approach the position of the virtual audio source of the audio information.

Although the details will be described later, according to the present example embodiment, a user U1 wears a communication terminal 20 that is, for example, a hearable device and that includes a left unit 20L to be worn on the left ear and a right unit 20R to be worn on the right ear. Then, in response to an instruction from the user U1, an information processing system virtually installs audio information to a site that needs repair R1 with use of direction information of the user U1. A user U2, meanwhile, wears a communication terminal 40 that is, for example, a hearable device and that includes a left unit 40L to be worn on the left ear and a right unit 40R to be worn on the right ear. Then, in response to the user U2 entering a predetermined region A1, the information processing system performs control of outputting, to the user U2, audio information subjected to a sound localization process with its installation position serving as a sound localization position, with use of direction information of the user U2.

While FIG. 3 shows a situation of road inspection, this is merely one example of situations to which the present example embodiment is applied, and the present example embodiment may be applied to other situations. For example, the present example embodiment can be applied to a situation in which a user virtually installs audio information to an exhibit on a wall in a museum or an art museum and in which the installed audio information is output to another user. Including such a situation, the present example embodiment can be applied to a situation in which, when, for example, audio information is virtually installed to a given position, this given position is set as a sound localization position.

### <Configuration Example of Information Processing System>

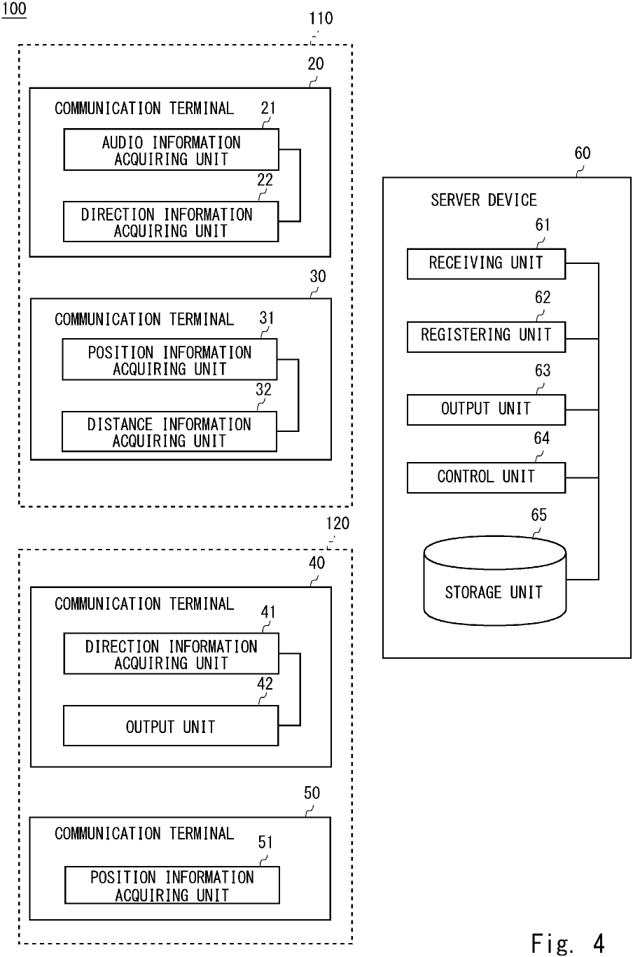

A configuration example of an information processing system 100 will be described with reference to FIG. 4. FIG. 4 illustrates a configuration example of the information processing system according to the second example embodiment. The information processing system 100 includes a server device 60, a user terminal 110 to be used by a user U1, and a user terminal 120 to be used by a user U2. The user U1 and the user U2 may be different users or the same user. In a case where the user U1 and the user U2 are the same user, the user terminal 110 is configured to include the functions of the user terminal 120. In FIG. 4, the server device 60 is depicted as a device separated from the user terminal 120. Alternatively, the server device 60 may be embedded into the user terminal 120, or the components of the server device 60 may be included in the user terminal 120.

The user terminal 110 is a communication terminal to be used by the user U1, and the user terminal 110 includes communication terminals 20 and 30. The user terminal 120 is a communication terminal to be used by the user U2, and the user terminal 120 includes communication terminals 40 and 50. The communication terminals 20 and 40 correspond to the communication terminals 20 and 40 shown in FIG. 3, and they are, for example, hearable devices. The communication terminals 30 and 50 are, for example, smartphone terminals, tablet terminals, mobile phones, or personal computer devices.

In the configuration according to the present example embodiment, the user terminals 110 and 120 each include two communication terminals. Alternatively, the user terminals 110 and 120 may each be, for example, a communication terminal, such as a head-mounted display, in which two communication terminals are integrated into a unit. In other words, the user terminals 110 and 120 may each be constituted by a single communication terminal. In this case, the user terminal 110 is configured to include the configuration of the communication terminal 20 and of the communication terminal 30, and the user terminal 120 is configured to include the configuration of the communication terminal 40 and of the communication terminal 50.

The communication terminal 20 is a communication terminal to be used by the user U1 and to be worn by the user U1. The communication terminal 20 is a communication terminal to be worn on the ears of the user U1, and the communication terminal 20 includes a left unit 20L to be worn on the left ear of the user U1 and a right unit 20R to be worn on the right ear of the user U1. Herein, the communication terminal 20 may be a communication terminal in which the left unit 20L and the right unit 20R are integrated into a unit.

The communication terminal 20 is a communication terminal capable of, for example, wireless communication that a communication service provider provides, and the communication terminal 20 communicates with the server device 60 via a network that a communication service provider provides. When the user U1 virtually installs audio information, the communication terminal 20 acquires the audio information. The audio information may be audio content that the user U1 has recorded or audio content held in the communication terminal 20. The communication terminal 20 transmits the acquired audio information to the server device 60. In this description, the communication terminal 20 (the left unit 20L and the right unit 20R) directly communicates with the server device 60. Alternatively, the communication terminal 20 (the left unit 20L and the right unit 20R) may communicate with the server device 60 via the communication terminal 30.

When the user U1 virtually installs audio information, the communication terminal 20 acquires direction information of the communication terminal 20 and transmits the acquired direction information to the server device 60. The server device 60 treats the direction information of the communication terminal 20 as direction information of the user terminal 110. The communication terminal 20 may regard the direction information of the communication terminal 20 as direction information of the user U1.

The communication terminal 30 is a communication terminal to be used by the user U1. The communication terminal 30 connects to and communicates with the communication terminal 20, for example, via wireless communication using Bluetooth (registered trademark), Wi-Fi, or the like. Meanwhile, the communication terminal 30 communicates with the server device 60, for example, via a network that a communication service provider provides.

When the user U1 virtually installs audio information, the communication terminal 30 acquires position information of the communication terminal 30 and transmits the acquired position information to the server device 60. The server device 60 treats the position information of the communication terminal 30 as position information of the user terminal 110. The communication terminal 20 may regard the direction information of the communication terminal 20 as direction information of the user U1. The communication terminal 30 may regard the position information of the communication terminal 30 as position information of the user U1. Herein, the communication terminal 30 may acquire position information of the left unit 20L and of the right unit 20R based on the position information of the communication terminal 30 and the distance to the left unit 20L and the right unit 20R.

The communication terminal 30 acquires distance information of a distance from the position indicated by the position information of the communication terminal 30 to an installation position to which the audio information is installed virtually. The communication terminal 30 transmits the acquired distance information to the server device 60. The installation position is a position to which the user U1 virtually installs audio information and corresponds to the site that needs repair R1 in the example shown in FIG. 3.

The communication terminal 40 is a communication terminal to be used by the user U2 and to be worn by the user U2. The communication terminal 40 is a communication terminal to be worn on the ears of the user U2, and the communication terminal 40 includes a left unit 40L to be worn on the left ear of the user U2 and a right unit 40R to be worn on the right ear of the user U2. Herein, the communication terminal 40 may be a communication terminal in which the left unit 40L and the right unit 40R are integrated into a unit.

The communication terminal 40 is a communication terminal capable of, for example, wireless communication that a communication service provider provides, and the communication terminal 40 communicates with the server device 60 via a network that a communication service provider provides. The communication terminal 40 acquires direction information of the communication terminal 40 and transmits the acquired direction information to the server device 60. The server device 60 treats the direction information of the communication terminal 40 as direction information of the user terminal 120. The communication terminal 40 may regard the direction information of the communication terminal 40 as direction information of the user U2.

The communication terminal 40 outputs audio information subjected to a sound localization process to each of the user’s ears. In this description, the communication terminal 40 (the left unit 40L and the right unit 40R) directly communicates with the server device 60. Alternatively, the communication terminal 40 (the left unit 40L and the right unit 40R) may communicate with the server device 60 via the communication terminal 50.

The communication terminal 50 is a communication terminal to be used by the user U2. The communication terminal 50 connects to and communicates with the communication terminal 40, for example, via wireless communication using Bluetooth, Wi-Fi, or the like. Meanwhile, the communication terminal 50 communicates with the server device 60, for example, via a network that a communication service provider provides.

The communication terminal 50 acquires position information of the communication terminal 50 and transmits the acquired position information to the server device 60. The server device 60 treats the position information of the communication terminal 50 as position information of the user terminal 120. The communication terminal 50 may regard the position information of the communication terminal 50 as position information of the user U2. Herein, the communication terminal 50 may acquire position information of the left unit 40L and of the right unit 40R based on the position information of the communication terminal 50 and the distance to the left unit 40L and the right unit 40R.

The server device 60 corresponds to the information processing device 1 according to the first example embodiment. The server device 60 communicates with the communication terminals 20, 30, 40, and 50, for example, via a network that a communication service provider provides.

The server device 60 receives, from the user terminal 110, the position information of the user terminal 110, the direction information of the user terminal 110, and the distance information of a distance from the position indicated by the position information of the user terminal 110 to the installation position to which the audio information is installed virtually. The server device 60 receives the audio information and the direction information of the communication terminal 20 from the communication terminal 20. The server device 60 receives the position information of the communication terminal 30 and the distance information from the communication terminal 30.

The server device 60 determines a sound localization position based on the position information, the direction information, and the distance information each received from the user terminal 110. The server device 60 registers the position information of the user terminal 110, sound localization position information regarding the sound localization position, and the audio information into the server device 60 with these pieces of information mapped to one another. The sound localization position information may be, for example, coordinates identified by a three-dimensional orthogonal coordinate system with its coordinate origin set at a predefined reference position, or may be, for example, position information indicated by the orientation and the height relative to a predefined reference position.

The server device 60 generates region information that specifies a region with the position information of the user terminal 110 serving as a reference. The server device 60 registers the generated region information into the server device 60 with the region information mapped to the sound localization position information. The region corresponds to the predetermined region A1 shown in FIG. 3 and is a virtually set region. Such a region may also be referred to as a geofence. Herein, the server device 60 may register the position information of the user terminal 110, the sound localization position information, the audio information, and the region information into a storage device external or internal to the server device 60.

The server device 60 receives the position information of the user terminal 120 and the direction information of the user terminal 120 from the user terminal 120. The server device 60 receives the direction information of the communication terminal 40 from the communication terminal 40. The server device 60 receives the position information of the communication terminal 50 from the communication terminal 50.

If the position indicated by the position information received from the user terminal 120 is encompassed by the region indicated by the region information, the server device 60 generates sound localization information based on the position information and the direction information each received from the user terminal 120 as well as the determined sound localization position information. The server device 60 performs control of outputting audio information corrected based on the sound localization information to the left unit 40L and the right unit 40R of the communication terminal 40.

### <Configuration Example of Communication Terminal>

Next, a configuration example of the communication terminal 20 will be described. The communication terminal 20 includes an audio information acquiring unit 21 and a direction information acquiring unit 22. Since the communication terminal 20 includes the left unit 20L and the right unit 20R, the left unit 20L and the right unit 20R each include an audio information acquiring unit 21 and a direction information acquiring unit 22. The direction and the height that the user U1 faces are supposedly substantially identical in the left and right ears. Therefore, either one of the left unit 20L and the right unit 20R may include an audio information acquiring unit 21 and a direction information acquiring unit 22.

An audio information acquiring unit 21 includes, for example but not limited to, a microphone and is configured to be capable of speech recognition of input audio. The audio information acquiring unit 21 receives an input of a registration instruction for audio information from the user U1. The registration instruction for audio information is an instruction for registering audio information in such a manner that the audio information is installed virtually to a position that the user has specified. When the user U1 records audio, the audio information acquiring unit 21 records the content uttered by the user U1 and generates the recorded content as audio information. If the user U1 inputs, for example, audio indicating a registration instruction for audio information, the audio information acquiring unit 21 transmits generated audio information to the server device 60. Herein, if a registration instruction for audio information received from the user U1 includes information specifying certain audio information, the audio information acquiring unit 21 may acquire the specified audio information from audio information stored in the communication terminal 20 and transmit the acquired audio information to the server device 60.

A direction information acquiring unit 22 is configured to include, for example but not limited to, a 9-axis sensor (triaxial acceleration sensor, triaxial gyro sensor, and triaxial compass sensor). The direction information acquiring unit 22 acquires the direction information of the communication terminal 20 with the 9-axis sensor. The direction information acquiring unit 22 acquires the orientation that the communication terminal 20 is facing and the elevation angle of the communication terminal 20. Since the communication terminal 20 is worn on both ears of the user U1, the orientation that the communication terminal 20 faces can be rephrased as information that indicates the facial direction that the face of the user U1 is pointing. The direction information acquiring unit 22 may acquire, as the elevation angle of the communication terminal 20, the inclination of the communication terminal 20 relative to the ground surface or a horizontal plane. The direction information acquiring unit 22 generates the direction information of the communication terminal 20 that includes the acquired orientation and the acquired elevation angle. The direction information acquiring unit 22 may regard the direction information of the communication terminal 20 as the direction information of the user U1. In response to receiving, for example, an input of a registration instruction for audio information from the user U1, the direction information acquiring unit 22 acquires the direction information of the communication terminal 20 and transmits the acquired direction information of the communication terminal 20 to the server device 60.

Since the direction information acquiring unit 22 includes the 9-axis sensor, the direction information acquiring unit 22 can acquire the posture of the user U1 as well. Therefore, the direction information may include posture information indicating the posture of the user U1. Since the direction information is data acquired by the 9-axis sensor, the direction information may also be referred to as sensing data.

Next, a configuration example of the communication terminal 30 will be described. The communication terminal 30 includes a position information acquiring unit 31 and a distance information acquiring unit 32.

The position information acquiring unit 31 is configured to include, for example, a global positioning system (GPS) receiver. The position information acquiring unit 31 receives GPS signals, acquires latitude and longitude information of the communication terminal 30 based on the received GPS signals, and uses the acquired latitude and longitude information as the position information of the communication terminal 30. The position information acquiring unit 31 may regard the position information of the communication terminal 30 as the position information of the user U1. In response to, for example, a registration instruction for audio information being input from the user U1, the position information acquiring unit 31 receives this instruction from the communication terminal 20, acquires the position information of the communication terminal 30, and transmits the position information of the communication terminal 30 to the server device 60. In other words, the position information acquiring unit 31 acquires the position information held when the user U1 has made a registration instruction for audio information to indicate that the user U1 is to virtually install audio information to an installation position, and the position information acquiring unit 31 transmits the acquired position information to the server device 60.

The distance information acquiring unit 32 acquires distance information of a distance from the position of the user U1 to the installation position to which the audio information is installed virtually. In response to an input of a registration instruction for audio information from the user U1, the distance information acquiring unit 32 receives this instruction from the communication terminal 20, acquires distance information, and transmits the distance information to the server device 60.

Functioning, for example, as an imaging unit, such as a camera, as well, the distance information acquiring unit 32 generates a captured image in response to capturing an image of the installation position to which the user U1 is to virtually install audio information. The distance information acquiring unit 32 may acquire the distance information by estimating the distance from the position of the user U1 to the installation position based on the captured image with use of the degree of zooming of the camera.

Conceivably, audio information is installed virtually to an object, such as the site that needs repair R1 shown in FIG. 3. Therefore, the distance information acquiring unit 32 may detect an object included in a captured image and acquire the distance information by estimating the distance to the detected object. Alternatively, the distance information acquiring unit 32 may be configured to be capable of acquiring the line of sight of the user U1, and the distance information acquiring unit 32 may acquire the distance information by representing the line of sight of the user U1 in the form of a pointer pointing the direction indicated by the direction information of the user U1 and by estimating the distance to this pointer. Alternatively, the distance information acquiring unit 32 may be configured to be capable of speech recognition of recognizing audio of the user U1, and the distance information acquiring unit 32 may acquire the distance information based on the audio that the user U1 has uttered, if the audio that the user U1 has uttered includes distance-related information. Alternatively, the distance information acquiring unit 32 may be configured to include an infrared sensor or a laser for measuring distance, and the distance information acquiring unit 32 may acquire the distance information by measuring the distance to an object included in a captured image with use of the infrared sensor or the laser.

Next, a configuration example of the communication terminal 40 will be described. The communication terminal 40 includes a direction information acquiring unit 41 and an output unit 42. Since the communication terminal 40 includes the left unit 40L and the right unit 40R, the left unit 40L and the right unit 40R may each include a direction information acquiring unit 41 and an output unit 42. The direction and the height that the user U2 faces are supposedly substantially identical in the left and right ears. Therefore, either one of the left unit 40L and the right unit 40R may include a direction information acquiring unit 41.

A direction information acquiring unit 41 is configured to include, for example but not limited to, a 9-axis sensor (triaxial acceleration sensor, triaxial gyro sensor, and triaxial compass sensor). The direction information acquiring unit 41 acquires the direction information of the communication terminal 40 with the 9-axis sensor. The direction information acquiring unit 41 acquires the orientation that the communication terminal 40 is facing and the elevation angle of the communication terminal 40. Since the communication terminal 40 is worn on the ears of the user U2, the orientation that the communication terminal 40 faces can be rephrased as information that indicates the facial direction that the face of the user U2 is pointing. The direction information acquiring unit 41 may acquire, as the elevation angle of the communication terminal 40, the inclination of the communication terminal 40 relative to a horizontal plane. The direction information acquiring unit 41 generates the direction information that includes the acquired orientation and the acquired elevation angle. The direction information acquiring unit 41 may regard the direction information of the communication terminal 40 as the direction information of the user U2. The direction information acquiring unit 41 acquires the direction information of the communication terminal 40 periodically or non-periodically. In response to acquiring the direction information of the communication terminal 40, the direction information acquiring unit 41 transmits the acquired direction information to the server device 60.

Since the direction information acquiring unit 41 includes the 9-axis sensor, the direction information acquiring unit 41 can acquire the posture of the user U2 as well. Therefore, the direction information may include posture information indicating the posture of the user U2. Since the direction information is data acquired by the 9-axis sensor, the direction information may also be referred to as sensing data.

The output unit 42 is configured to include, for example but not limited to, a stereo speaker. The output unit 42, functioning as a communication unit as well, receives audio information subjected to a sound localization process from the server device 60 and outputs the received audio information to the user’s ears. If the output unit 42 has received audio information subjected to a sound localization process from the server device 60, the output unit 42 switches the audio information to be output from the audio information presently being output to the received audio information at a predetermined timing. The audio information subjected to the sound localization process includes left-ear audio information for the left unit 40L and right-ear audio information for the right unit 40R. The output unit 42 of the left unit 40L outputs the left-ear audio information, and the output unit 42 of the right unit 40R outputs the right-ear audio information.

Next, a configuration example of the communication terminal 50 will be described. The communication terminal 50 includes a position information acquiring unit 51.

The position information acquiring unit 51 is configured to include, for example, a GPS receiver. The position information acquiring unit 51 receives GPS signals, acquires latitude and longitude information of the communication terminal 50 based on the received GPS signals, and uses the acquired latitude and longitude information as the position information of the communication terminal 50. In response to acquiring the position information of the communication terminal 50, the position information acquiring unit 51 transmits the position information of the communication terminal 50 to the server device 60. The position information acquiring unit 51 acquires the position information of the communication terminal 50 periodically or non-periodically. The position information acquiring unit 51 transmits the acquired position information to the server device 60. The position information acquiring unit 51 may acquire the latitude and longitude information of the communication terminal 50 as the position information of the user U2.

### <Configuration Example of Server Device>

Next, a configuration example of the server device 60 will be described. The server device 60 includes a receiving unit 61, a registering unit 62, an output unit 63, a control unit 64, and a storage unit 65.

The receiving unit 61 corresponds to the receiving unit 2 according to the first example embodiment. The receiving unit 61 receives audio information, position information of the user terminal 110, direction information of the user terminal 110, and distance information from the user terminal 110. The distance information is distance information of a distance from the position indicated by the position information of the user terminal 110 to an installation position to which the audio information is installed virtually.

Specifically, the receiving unit 61 receives the audio information and the direction information of the communication terminal 20 from the communication terminal 20 and receives the position information of the communication terminal 30 and the distance information from the communication terminal 30. The receiving unit 61 outputs the direction information of the communication terminal 20 to the registering unit 62 as the direction information of the user terminal 110. The receiving unit 61 outputs the position information of the communication terminal 30 to the registering unit 62 as the position information of the user terminal 110. The receiving unit 61 may further receive a registration instruction for audio information from the communication terminal 20.

The receiving unit 61 receives position information of the user terminal 120 and direction information of the user terminal 120 from the user terminal 120. Specifically, the receiving unit 61 receives the direction information of the communication terminal 40 from the communication terminal 40 and receives the position information of the communication terminal 50 from the communication terminal 50. The receiving unit 61 outputs the direction information of the communication terminal 40 to the output unit 63 as the direction information of the user terminal 120. The receiving unit 61 outputs the position information of the communication terminal 50 to the output unit 63 as the position information of the user terminal 120.

The registering unit 62 corresponds to the registering unit 3 according to the first example embodiment. The registering unit 62 determines a sound localization position based on the position information of the user terminal 110, the direction information of the user terminal 110, and the distance information. The registering unit 62 determines an installation position to which the audio information is installed virtually based on the position information of the user terminal 110, the direction information of the user terminal 110, and the distance information. The direction information includes the orientation that the user terminal 110 faces and the elevation angle of the user terminal 110. Therefore, the registering unit 62 can identify the installation position by use of the position information of the user terminal 110, the orientation and the elevation angle included in the direction information of the user terminal 110, and the distance information. The registering unit 62 determines the determined installation position as the sound localization position. The registering unit 62 registers the position information of the user terminal 110, sound localization position information regarding the sound localization position, and the audio information into the storage unit 65 with these pieces of information mapped to one another.

The registering unit 62 generates region information that specifies a region with the position indicated by the position information of the user terminal 110 serving as a reference. The registering unit 62 generates region information that specifies a region with the position indicated by the position information of the user terminal 110 serving, for example, as the center. The registering unit 62 registers the generated region information into the storage unit 65 with the region information mapped to the sound localization position information. The region corresponds to the predetermined region A1 shown in FIG. 3 and is a virtually set region. This region may also be referred to as a geofence. In the following description, the region may also be referred to as a geofence.

A geofence may have any desired shape, such as a circular shape, a spherical shape, a rectangular shape, or a polygonal shape, and is specified based on region information. Region information includes, for example, size information that specifies the size of the geofence, and the geofence is specified by the size information. The size information may indicate, for example, the radius of the geofence, if the geofence has a circular shape or a spherical shape. Meanwhile, when the geofence has a polygonal shape, including a rectangular shape, the size information may indicate, for example, the distance from the center of the polygonal shape (sound localization position) to each vertex of the polygonal shape. In the following description, the geofence is a circle that is set along a plane parallel to a horizontal plane and for which the position indicated by the position information of the user terminal 110 serves as a reference, and the size information indicates the radius of this circle. Size information may be referred to as length information specifying a geofence or as region distance information specifying a geofence.

The registering unit 62 generates a circular geofence having a predefined radius. To rephrase, the registering unit 62 generates region information in which the size information indicates a predefined distance. Herein, the radius of the geofence may be set as desired by the user U1.

The registering unit 62 adjusts the size information in accordance with the distance information received from the user terminal 110. If the registering unit 62 has changed the size information, the registering unit 62 updates the region information registered in the storage unit 65 based on the changed size information. According to the present example embodiment, the registering unit 62 adjusts the size information in accordance with the distance information received from the user terminal 110 of the user U1. Alternatively, the registering unit 62 may be configured not to adjust the size information.

The registering unit 62 may adjust the size information to reduce the size of the geofence, if the distance indicated by the distance information is no smaller than a predetermined value. The registering unit 62 may change the size information to, for example, reduce the size to one-half the distance indicated by the distance information, if the distance indicated by the distance information is no smaller than a predetermined value.

Meanwhile, the registering unit 62 may adjust the size information to increase the size of the geofence, if the distance indicated by the distance information is smaller than a predetermined value. The registering unit 62 may change the size information to, for example, make the size equal to the distance indicated by the distance information, if the distance indicated by the distance information is smaller than a predetermined value.

The output unit 63 determines whether the position indicated by the position information of the user terminal 120 is encompassed by a geofence specified by region information. Specifically, the output unit 63 determines whether the position information of the user terminal 120 is encompassed by the region information. If the position information of the user terminal 120 is encompassed by the region information, the output unit 63 determines that the position indicated by the position information of the user terminal 120 is encompassed by the geofence specified by the region information.

If the position indicated by the position information of the user terminal 120 is encompassed by the geofence, the output unit 63 generates sound localization information that is based on a sound localization position, based on the position information of the user terminal 120, the direction information of the user terminal 120, altitude information of the user terminal 120, and sound localization position information.

Sound localization information is a parameter to be used to execute a sound localization process on audio information. To rephrase, sound localization information is a parameter used to make correction so that the audio information can sound as audio coming from the sound localization position.

The output unit 63 generates left-ear sound localization information for the left unit 40L and right-ear sound localization information for the right unit 40R, based on the position information of the user terminal 120, the direction information of the user terminal 120, and sound localization position information. The output unit 63 outputs sound localization information that includes the left-ear sound localization information and the right-ear sound localization information as well as the sound localization position information to the control unit 64.

The control unit 64 acquires, from the storage unit 65, audio information mapped to the sound localization position information output from the output unit 63. The control unit 64 executes a sound localization process on the acquired audio information based on the sound localization information that the output unit 63 has generated. To rephrase, the control unit 64 corrects the acquired audio information based on the sound localization information. The control unit 64 generates left-ear audio information by correcting the audio information based on the left-ear sound localization information. The control unit 64 generates right-ear audio information by correcting the audio information based on the right-ear sound localization information.

The control unit 64, functioning as a communication unit as well, transmits the left-ear audio information and the right-ear audio information to, respectively, the left unit 40L and the right unit 40R of the communication terminal 40. Each time the output unit 63 generates sound localization information, the control unit 64 generates left-ear audio information and right-ear audio information based on the latest sound localization information and transmits the generated left-ear audio information and right-ear audio information to the left unit 40L and the right unit 40R, respectively. The control unit 64 performs control of outputting the left-ear audio information and the right-ear audio information to the output unit 43 of the left unit 40L and of the right unit 40R of the communication terminal 40.

The storage unit 65 stores, in accordance with the control of the registering unit 62, the position information of the user terminal 110, the audio information, the sound localization position information, and the region information with these pieces of information mapped to one another. The storage unit 65 updates the region information based on the changed size information, in accordance with the control of the registering unit 62.

### <Operation Example of Server Device>

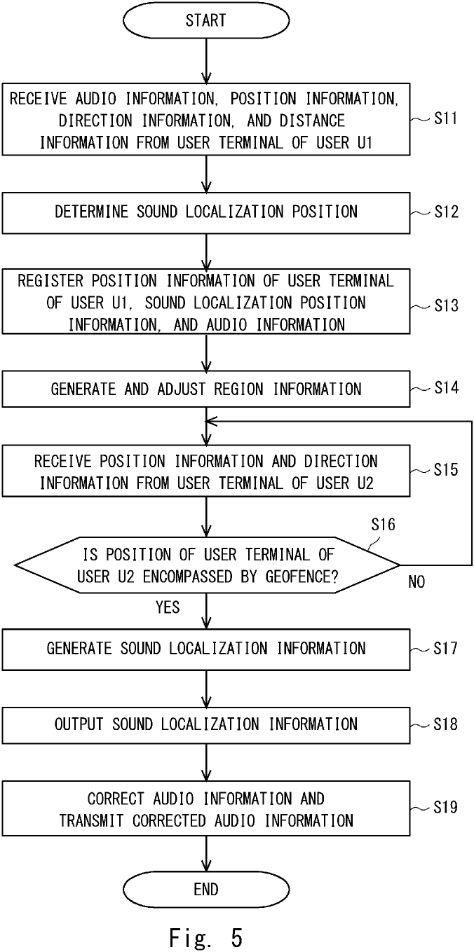

Next, an operation example of the server device 60 according to the second example embodiment will be described with reference to FIG. 5. FIG. 5 is a flowchart illustrating an operation example of the server device according to the second example embodiment. The flowchart shown in FIG. 5 roughly includes an audio information registration process executed at steps S11 to S14 and an audio information output process executed at steps S15 to S19. The audio information registration process is executed in response to the user U1 issuing a registration instruction for audio information to virtually install audio information to an installation position. The audio information output process is executed repeatedly each time the server device 60 acquires position information and direction information of the user U2.

The receiving unit 61 receives audio information, position information of the user terminal 110, direction information of the user terminal 110, and distance information from the user terminal 110 (step S11). The receiving unit 61 receives the audio information and the direction information of the communication terminal 20 from the communication terminal 20 and receives the position information of the communication terminal 30 and the distance information from the communication terminal 30. The receiving unit 61 outputs the direction information of the communication terminal 20 to the registering unit 62 as the direction information of the user terminal 110. The receiving unit 61 outputs the position information of the communication terminal 30 to the registering unit 62 as the position information of the user terminal 110.

The registering unit 62 determines a sound localization position based on the position information of the user terminal 110, the direction information of the user terminal 110, and the distance information (step S12). The registering unit 62 determines an installation position to which the audio information is installed virtually, based on the position information of the user terminal 110, the direction information of the user terminal 110, and the distance information. The registering unit 62 determines the determined installation position as the sound localization position.

The registering unit 62 registers sound localization position information regarding the sound localization position of the user terminal 110 and the audio information into the storage unit 65 with these pieces of information mapped to each other (step S13).

The registering unit 62 generates and adjusts region information that specifies a geofence with the position indicated by the position information of the user terminal 110 serving as a reference (step S14). The registering unit 62 generates region information that specifies a geofence with the position indicated by the position information of the user terminal 110 serving as a reference. The registering unit 62 registers the generated region information into the storage unit 65 with the region information mapped to the sound localization position information. The registering unit 62 adjusts the size information included in the region information in accordance with the distance information.

The receiving unit 61 receives position information of the user terminal 120 and direction information of the user terminal 120 from the user terminal 120 (step S15). The receiving unit 61 receives the direction information of the communication terminal 40 from the communication terminal 40 and receives the position information of the communication terminal 50 from the communication terminal 50. The receiving unit 61 outputs the direction information of the communication terminal 40 to the output unit 63 as the direction information of the user terminal 120. The receiving unit 61 outputs the position information of the communication terminal 50 to the output unit 63 as the position information of the user terminal 120.

The output unit 63 determines whether the position indicated by the position information of the user terminal 120 is encompassed by the geofence (step S16). The output unit 63 determines whether the position information of the user terminal 120 is encompassed by the region information. If the position information of the user terminal 120 is encompassed by the region information, the output unit 63 determines that the position indicated by the position information of the user terminal 120 is encompassed by the geofence specified by the region information.

If the position indicated by the position information of the user terminal 120 is encompassed by the geofence (YES at step S16), the output unit 63 generates sound localization information based on the position information and the direction information of the user terminal 120 and the sound localization position information (step S17). The output unit 63 generates sound localization information that is based on the determined sound localization position. The output unit 63 generates left-ear sound localization information for the left unit 40L and right-ear sound localization information for the right unit 40R, based on the position information of the user terminal 120, the direction information of the user terminal 120, and the sound localization position information. The output unit 63 outputs the sound localization information that includes the left-ear sound localization information and the right-ear sound localization information as well as the sound localization position information to the control unit 64.

Meanwhile, if the position indicated by the position information of the user terminal 120 is not encompassed by the geofence (NO at step S16), the server device 60 returns to step S15 and executes step S15.

At step S18, the output unit 63 outputs the sound localization information to the control unit 64 (step S18). Herein, the output unit 63 outputs the sound localization information that includes the left-ear sound localization information and the right-ear sound localization information as well as the sound localization position information to the control unit 64.

The control unit 64 corrects the audio information and transmits the corrected audio information to the output unit 43 of the communication terminal 40 (step S19). The control unit 64 acquires, from the storage unit 65, the audio information mapped to the sound localization position information output from the output unit 63. The control unit 64 corrects the acquired audio information based on the sound localization information. The control unit 64 generates left-ear audio information by correcting the audio information based on the left-ear sound localization information and generates right-ear audio information by correcting the audio information based on the right-ear sound localization information. The control unit 64 transmits the left-ear audio information and the right-ear audio information to, respectively, the left unit 40L and the right unit 40R of the communication terminal 40.

As described above, the receiving unit 61 receives not only the position information of the user terminal 110 but also the direction information of the user terminal 110 and the distance information. The registering unit 62 determines the sound localization position based on the position information of the user terminal 110, the direction information of the user terminal 110, and the distance information. In this manner, since the registering unit 62 determines the sound localization position with use of the direction information of the user terminal 110 and the distance information, even in a case where the user U1 wants to virtually install audio information to a position different from the position where the user U1 is present, the sound localization position can be set to a desired position. To rephrase, even in a case where the position to which the user U1 wants to virtually install audio information is a position that the user U1 cannot approach, the user U1 can virtually install the audio information to the desired position. Therefore, the information processing system 100 according to the second example embodiment makes it possible to set a sound localization position to the user’s desired position. Accordingly, the information processing system 100 according to the second example embodiment makes it possible to output audio information whose acoustic image is localized to the user’s desired position.

The server device 60 includes the output unit 63 and the control unit 64. If the user U2 is within a geofence, the server device 60 outputs, to the user U2, audio information subjected to a sound localization process based on the position information of the user terminal 120, the direction information of the user terminal 120, and the sound localization position information. To rephrase, the server device 60 corrects audio information in such a manner that the audio information sounds as if it is output from the installation position to which the audio information has been installed by the user U1, and outputs the corrected audio information to the user U2. In this manner, the information processing system 100 according to the second example embodiment allows the user U2 to easily identify the installation position as the user U2 moves in the direction of the virtual audio source of the audio information. In the example shown in FIG. 3, the user U2 serving as a maintenance personnel can easily identify the site that needs repair R1 that the user U1 serving as an inspector has found, as the user U2 moves in the direction of the virtual audio source of the audio information. Accordingly, the information processing system 100 according to the second example embodiment can contribute to increased work efficiency. Furthermore, the information processing system 100 according to the second example embodiment can guide the user U2 in the direction of the virtual audio source of the audio information.

### (Modification Example 1)

According to the second example embodiment, the registering unit 62 adjusts the size information in accordance with the distance information received from the user U1. Alternatively, the registering unit 62 may adjust the size information with use of the size of an object located at a sound localization position. This case can be implemented by modifying the second example embodiment as follows.

The distance information acquiring unit 32, for example, functions as an imaging unit, such as a camera, and the distance information acquiring unit 32 captures an image of an imaging region that includes a sound localization position and generates a captured image. The distance information acquiring unit 32 transmits the captured image and the degree of zooming of the camera to the server device 60.

The receiving unit 61 receives the captured image and the degree of zooming from the distance information acquiring unit 32.

The registering unit 62, being configured to be capable of performing an image analysis, analyzes the captured image and identifies an object included in the captured image. The registering unit 62 identifies the size of the object based on the degree of zooming of the camera and the captured image. A user typically captures an image with the center of the imaging region set on an item (object) that the user is focusing on. Therefore, the registering unit 62, regarding an item located at the center of the imaging region as the object, identifies the size of the object based on the degree of zooming of the camera and the captured image. The registering unit 62 adjusts the size information based on the size of the object. Herein, a captured image typically includes a plurality of items, and thus the registering unit 62 may identify the size of the object based on the size of an item that is included in the captured image and whose size is known, without using the degree of zooming of the camera.

If the identified size of the object is no smaller than a predetermined value, the registering unit 62 may change the size information such that the size of the geofence takes a first size. Even if the identified size of the object is no smaller than a predetermined value, the registering unit 62 does not need to change the size information and may change the size information to reduce the distance to a distance shorter than a predefined distance.

Meanwhile, if the identified size of the object is smaller than a predetermined value, the registering unit 62 may change the size information such that the size of the geofence takes a second size smaller than the first size. If the identified size of the object is smaller than a predetermined value, the registering unit 62 may change the size information to reduce the distance to a distance shorter than a predefined distance. Alternatively, the registering unit 62 may change the size information such that the distance becomes smaller than the distance held when the identified size of the object is no smaller than a predetermined value.

### (Modification Example 2)

According to Modification Example 1, the registering unit 62 identifies the size of an object based on a captured image. Alternatively, the registering unit 62 may identify the size of an object based on object information of the object and object position information of the object. This case can be implemented by modifying the second example embodiment as follows.

The storage unit 65 stores object information of a plurality of objects and object position information of the plurality of objects with these pieces of information mapped to each other. The object information may be information in which object identification information that identifies an object and the size of the object are mapped to each other.

The registering unit 62 identifies, of the object position information stored in the storage unit 65, object position information that includes sound localization position information. Then, the registering unit 62 identifies the size of the object based on the object information mapped to the identified object position information. The registering unit 62 adjusts the size information based on the size of the object. Herein, the registering unit 62 may adjust the size information in a manner similar to how the registering unit 62 adjusts the size information according to Modification Example 1.

### Third Example Embodiment

Next, a third example embodiment will be described. According to the second example embodiment, Modification Example 1, and Modification Example 2, the server device 60 executes a sound localization process on audio information. According to the third example embodiment, a user terminal 120 executes a sound localization process on audio information. Herein, the third example embodiment is basically similar to the second example embodiment, Modification Example 1, or Modification Example 2, and thus description thereof will be omitted, as appropriate.

### <Configuration Example of Information Processing System>

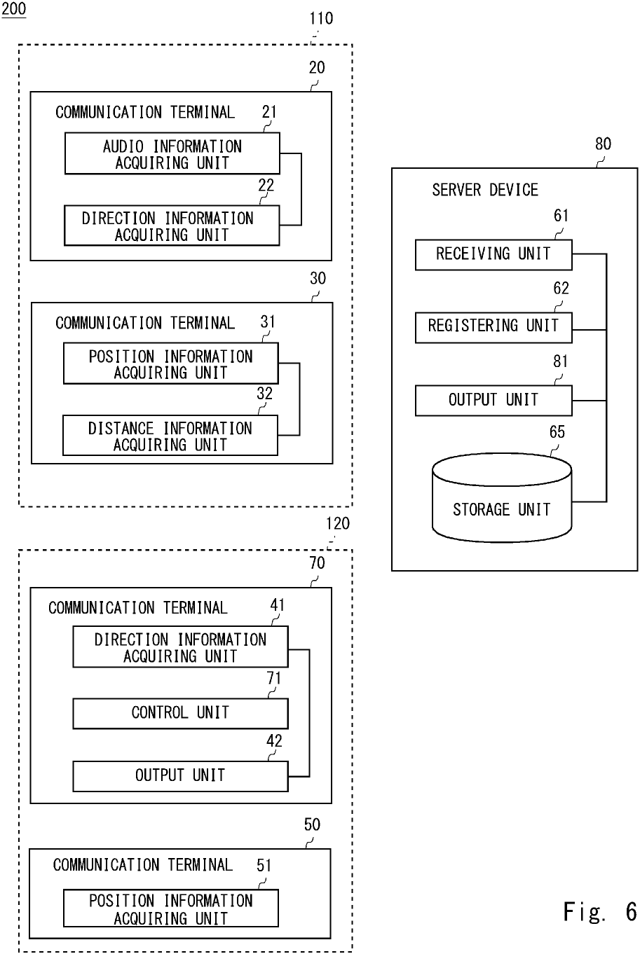

An information processing system 200 according to the third example embodiment will be described with reference to FIG. 6. FIG. 6 illustrates a configuration example of the information processing system according to the third example embodiment. The information processing system 200 includes a user terminal 110, a user terminal 120, and a server device 80. The user terminal 110 includes communication terminals 20 and 30. The user terminal 120 includes communication terminals 50 and 70.

The information processing system 200 has a configuration in which the communication terminal 40 according to the second example embodiment is replaced with the communication terminal 70 and the server device 60 is replaced with the server device 80. Configuration examples and operation examples of the communication terminals 20, 30, and 50 are similar to those according to the second example embodiment, and thus description thereof will be omitted, as appropriate.

### <Configuration Example of Communication Terminal>

Next, a configuration example of the communication terminal 70 will be described. The communication terminal 70 includes a direction information acquiring unit 41, a control unit 71, and an output unit 42. The communication terminal 70 has a configuration in which the control unit 71 is added to the configuration of the communication terminal 40 according to the second example embodiment. The configuration of the direction information acquiring unit 41 and the configuration of the output unit 42 are basically similar to those according to the second example embodiment, and thus description thereof will be omitted, as appropriate. According to the present example embodiment, the communication terminal 70 includes the control unit 71. Alternatively, the communication terminal 50 may include the control unit 71, and the communication terminal 70 may not include the control unit 71.

The control unit 71, functioning as a communication unit as well, communicates with the server device 80. The control unit 71 receives audio information and sound localization information from an output unit 81 of the server device 80. The control unit 71 executes a sound localization process on the audio information based on the sound localization information. To rephrase, the control unit 71 corrects the audio information based on the sound localization information.

As with the second example embodiment, the sound localization information includes left-ear sound localization information and right-ear sound localization information. The control unit 71 generates left-ear audio information by correcting the audio information based on the left-ear sound localization information and generates right-ear audio information by correcting the audio information based on the right-ear sound localization information.

The control unit 71 outputs the left-ear audio information and the right-ear audio information to the output unit 42. Each time the output unit 81 generates sound localization information, the control unit 71 generates left-ear audio information and right-ear audio information based on the latest sound localization information, and outputs the left-ear audio information and the right-ear audio information to the respective output units 42.

The output units 42 receive the audio information on which the control unit 71 has executed a sound localization process, and output the received audio information to the user’s ears. The output unit 42 of the left unit 40L outputs the left-ear audio information, and the output unit 42 of the right unit 40R outputs the right-ear audio information. If the output units 42 have received audio information subjected to a sound localization process from the control unit 71, the output units 42 switch the audio information to be output from the audio information presently being output to the received audio information at a predetermined timing.

### <Configuration Example of Server Device>

Next, a configuration example of the server device 80 will be described. The server device 80 includes a receiving unit 61, a registering unit 62, the output unit 81, and a storage unit 65. The server device 80 has a configuration in which the server device 80 does not include the control unit 64 according to the second example embodiment and the output unit 63 is replaced with the output unit 81. The receiving unit 61, the registering unit 62, and the storage unit 65 have configurations basically similar to those according to the second example embodiment, and thus description thereof will be omitted, as appropriate.

The output unit 81, functioning as a communication unit as well, transmits (outputs) sound localization information that the output unit 81 has generated and that includes left-ear sound localization information and right-ear sound localization information to the control unit 71. The output unit 81 transmits sound localization information to the control unit 71 each time the output unit 81 generates sound localization information. The output unit 81 controls the control unit 71 such that the control unit 71 performs a sound localization process with use of the latest sound localization information.

The output unit 81 acquires, from the storage unit 65, audio information mapped to the sound localization position information used to generate the sound localization information. The output unit 81 transmits (outputs) the acquired audio information to the control unit 71. Herein, when the output unit 81 has generated sound localization information, if the output unit 81 has already transmitted audio information to the control unit 71, the output unit 81 refrains from retransmitting the audio information to the control unit 71.

### <Operation Example of Information Processing System>

Next, an operation example of the information processing system 200 according to the third example embodiment will be described. The operation example of the information processing system 200 is basically similar to the operation example illustrated in FIG. 5, and thus the operation example will be described with reference to FIG. 5.

The operations from step S11 to step S17 are similar to those shown in FIG. 5, and thus description thereof will be omitted, as appropriate.

The output unit 81 outputs (transmits) the sound localization information to the control unit 71 (step S18). The output unit 81 transmits the generated sound localization information to the control unit 71. The output unit 81 acquires, from the storage unit 65, audio information mapped to the sound localization position information used to generate the sound localization information. The output unit 81 transmits (outputs) the acquired audio information to the control unit 71.

The control unit 71 corrects the audio information and transmits (outputs) the corrected audio information to the output unit 42 (step S19). The control unit 71 receives the audio information and the sound localization information from the output unit 81. The control unit 71 corrects the audio information based on the sound localization information and transmits (outputs) the corrected audio information to the output unit 42.

As described above, even when the configuration of the second example embodiment is configured as in the third example embodiment, advantageous effects similar to those provided by the second example embodiment can be obtained. In the configuration according to the third example embodiment, a sound localization process on audio information is executed by the communication terminal 70. If the server device 80 performs a sound localization process on audio information to be output to all the communication terminals, as in the second example embodiment, the processing load of the server device 80 increases with an increase in the number of communication terminals. Therefore, additional server devices need to be provided depending on the number of communication terminals. In this respect, according to the third example embodiment, the server device 80 does not execute a sound localization process on audio information, and the communication terminal 70 instead executes a sound localization process. Therefore, the processing load of the server device 80 can be reduced. Accordingly, with the information processing system 200 according to the third example embodiment, any equipment cost that could be incurred by additional servers can be suppressed.

Furthermore, the configuration according to the third example embodiment can reduce the network load. According to the second example embodiment, corrected audio information needs to be transmitted each time sound localization information is updated. In contrast, according to the third example embodiment, if the output unit 81 has already transmitted audio information to the control unit 71, the output unit 81 refrains from retransmitting audio information and only needs to transmit sound localization information. Accordingly, with the information processing system 200 according to the third example embodiment, the network load can be reduced.

### Fourth Example Embodiment

Next, a fourth example embodiment will be described. The fourth example embodiment is an improvement example of the second and third example embodiments. The present example embodiment will be described based on the second example embodiment, with configuration examples and operation examples similar to those according to the second example embodiment omitted, as appropriate.

### <Configuration Example of Information Processing System>

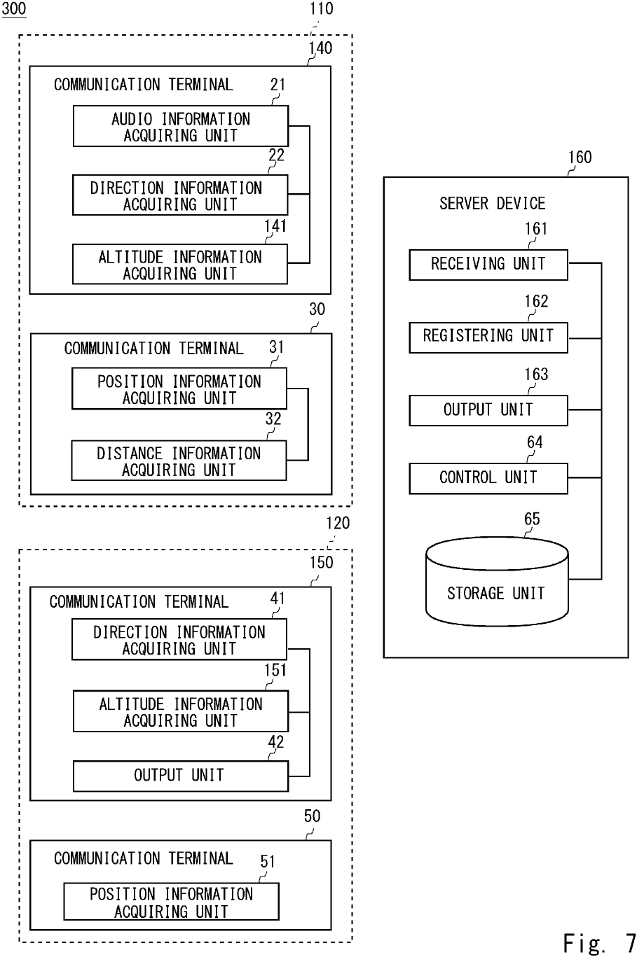

An information processing system 300 according to the fourth example embodiment will be described with reference to FIG. 7. FIG. 7 illustrates a configuration example of the information processing system according to the fourth example embodiment. The information processing system 300 includes a user terminal 110, a user terminal 120, and a server device 160. The user terminal 110 includes communication terminals 140 and 30. The user terminal 120 includes communication terminals 150 and 50.

The information processing system 300 has a configuration in which the communication terminal 20 according to the second example embodiment is replaced with the communication terminal 140, the communication terminal 40 is replaced with the communication terminal 150, and the server device 60 is replaced with the server device 160. Configuration examples and operation examples of the communication terminals 30 and 50 are similar to those according to the second example embodiment, and thus description thereof will be omitted, as appropriate.

### <Configuration Example of Communication Terminal>

Next, a configuration example of the communication terminal 140 will be described. The communication terminal 140 includes an audio information acquiring unit 21, a direction information acquiring unit 22, and an altitude information acquiring unit 141. The communication terminal 140 has a configuration in which the altitude information acquiring unit 141 is added to the configuration of the communication terminal 20 according to the second example embodiment. The configuration of the audio information acquiring unit 21 and the configuration of the direction information acquiring unit 22 are basically similar to those according to the second example embodiment, and thus description thereof will be omitted, as appropriate.

The communication terminal 140 includes a left unit 20L and a right unit 20R, and thus the left unit 20L and the right unit 20R each include an altitude information acquiring unit 141. The right and left ears of the user U1 are supposedly at a substantially identical height. Therefore, either one of the left unit 20L and the right unit 20R may include an altitude information acquiring unit 141.

An altitude information acquiring unit 141 is configured to include, for example, an altitude sensor. In response to receiving an input of a registration instruction for audio information from the user U1, the altitude information acquiring unit 141 acquires altitude information of the communication terminal 140 with the altitude sensor and transmits the acquired altitude information to the server device 160. The altitude information is information that indicates the height of the communication terminal 140 relative to the ground surface or a horizontal plane.

Next, a configuration example of the communication terminal 150 will be described. The communication terminal 150 includes a direction information acquiring unit 41, an altitude information acquiring unit 151, and an output unit 42. The communication terminal 150 has a configuration in which the altitude information acquiring unit 151 is added to the configuration of the communication terminal 40 according to the second example embodiment. The configuration of the direction information acquiring unit 41 and the configuration of the output unit 42 are basically similar to those according to the second example embodiment, and thus description thereof will be omitted, as appropriate.

The communication terminal 150 includes a left unit 40L and a right unit 40R, and thus the left unit 40L and the right unit 40R each include an altitude information acquiring unit 151. The right and left ears of the user U2 are supposedly at a substantially identical height. Therefore, either one of the left unit 40L and the right unit 40R may include an altitude information acquiring unit 151.

An altitude information acquiring unit 151 is configured to include, for example, an altitude sensor. The altitude information acquiring unit 151, for example, acquires altitude information of the communication terminal 150 with the altitude sensor at the timing at which the direction information acquiring unit 41 acquires direction information, and transmits the acquired altitude information to the server device 160. The altitude information is information that indicates the height of the communication terminal 150 relative to the ground surface or a horizontal plane.

### <Configuration Example of Server Device>

Next, a configuration example of the server device 160 will be described. The server device 160 includes a receiving unit 161, a registering unit 162, an output unit 163, a control unit 64, and a storage unit 65. The server device 160 has a configuration in which the receiving unit 61, the registering unit 62, and the output unit 63 according to the second example embodiment are replaced with, respectively, the receiving unit 161, the registering unit 162, and the output unit 163. The configuration of the control unit 64 and the configuration of the storage unit 65 are basically similar to those according to the second example embodiment, and thus description thereof will be omitted, as appropriate.

The receiving unit 161 further receives altitude information of the user terminal 110 from the user terminal 110. The receiving unit 161 receives the altitude information of the communication terminal 140 from the communication terminal 140 and outputs the altitude information of the communication terminal 140 to the registering unit 162 as the altitude information of the user terminal 110.

The receiving unit 161 receives altitude information of the user terminal 120 from the user terminal 120. The receiving unit 161 receives the altitude information of the communication terminal 150 from the communication terminal 150 and outputs the altitude information of the communication terminal 150 to the output unit 63 as the altitude information of the user terminal 120. The receiving unit 61 outputs the position information of the communication terminal 50 to the output unit 163 as the position information of the user terminal 120.

The registering unit 162 determines a sound localization position with further use of the altitude information of the user terminal 110. The registering unit 162 determines an installation position to which the audio information is installed virtually, based on the position information of the user terminal 110, the direction information of the user terminal 110, the altitude information of the user terminal 110, and the distance information. The registering unit 162 determines the determined installation position as the sound localization position. The registering unit 162 registers the position information of the user terminal 110, sound localization position information regarding the sound localization position, and the audio information into the storage unit 65 with these pieces of information mapped to one another.

If the position indicated by the position information of the user terminal 120 is encompassed by a geofence, the output unit 163 generates sound localization information that is based on the sound localization position, based on the position information of the user terminal 120, the direction information of the user terminal 120, the altitude information of the user terminal 120, and the sound localization position information.

Herein, if the height of the position where the user U1 who virtually installs audio information is located and the height of the position where the user U2 who listens to the audio information is located are the same, the output unit 163 may generate sound localization information without using the altitude information of the user terminal 120. Alternatively, if the height of the sound localization position is the same as the height of the user U1 and of the user U2, the output unit 163 may generate sound localization information without using the altitude information of the user terminal 120.

The output unit 163 generates left-ear sound localization information for the left unit 40L and right-ear sound localization information for the right unit 40R, based on the position information of the user terminal 120, the direction information of the user terminal 120, the altitude information of the user terminal 120, and the sound localization position information. The output unit 163 outputs sound localization information that includes the left-ear sound localization information and the right-ear sound localization information as well as the sound localization position information to the control unit 64.

### <Operation Example of Server Device>

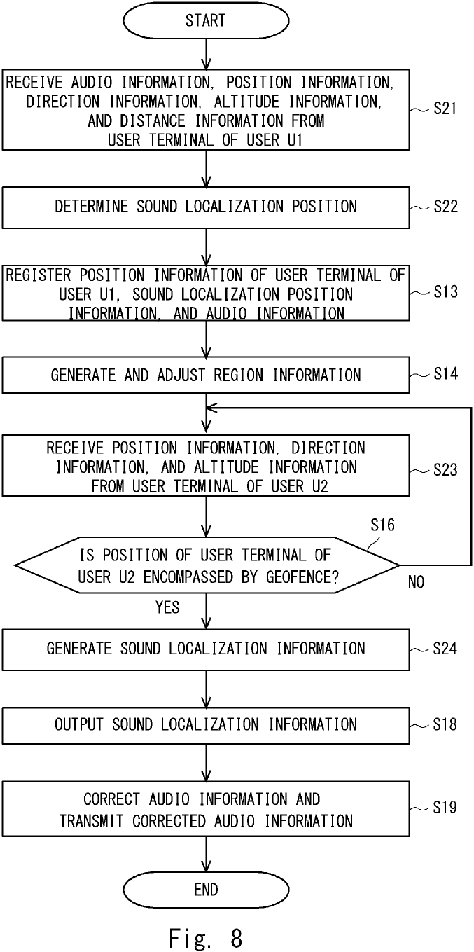

Next, an operation example of the server device 160 according to the fourth example embodiment will be described with reference to FIG. 8. FIG. 8 is a flowchart illustrating an operation example of the server device according to the fourth example embodiment. In FIG. 8, which corresponds to FIG. 5, steps S11, S12, S15, and S17 shown in FIG. 5 are replaced with, respectively, steps S21, S22, S23, and S24. The steps S13, S14, S16, S18, and S19 shown in FIG. 8 are basically similar to those shown in FIG. 5, and thus description thereof will be omitted, as appropriate.

The receiving unit 161 receives audio information, position information of the user terminal 110, direction information of the user terminal 110, altitude information of the user terminal 110, and distance information from the user terminal 110 (step S21). The receiving unit 161 receives the audio information, the direction information of the communication terminal 140, and the altitude information of the communication terminal 140 from the communication terminal 140, and receives the position information of the communication terminal 30 and the distance information from the communication terminal 30. The receiving unit 161 outputs the direction information of the communication terminal 140 and the altitude information of the communication terminal 140 to the registering unit 162 as, respectively, the direction information of the user terminal 110 and the altitude information of the user terminal 110. The receiving unit 161 outputs the position information of the communication terminal 30 to the registering unit 162 as the position information of the user terminal 110.

The registering unit 162 determines a sound localization position based on the position information of the user terminal 110, the direction information of the user terminal 110, the altitude information of the user terminal 110, and the distance information (step S22). The registering unit 162 determines an installation position to which the audio information is installed virtually, based on the position information of the user terminal 110, the direction information of the user terminal 110, the altitude information of the user terminal 110, and the distance information. The registering unit 162 determines the determined installation position as the sound localization position.

At step S23, the receiving unit 161 receives position information of the user terminal 120, direction information of the user terminal 120, and altitude information of the user terminal 120 from the user terminal 120 (step S23). The receiving unit 161 receives the direction information of the communication terminal 150 and the altitude information of the communication terminal 150 from the communication terminal 150, and receives the position information of the communication terminal 50 from the communication terminal 50. The receiving unit 161 outputs the direction information of the communication terminal 150 and the altitude information of the communication terminal 150 to the output unit 163 as, respectively, the direction information of the user terminal 120 and the altitude information of the user terminal 120. The receiving unit 161 outputs the position information of the communication terminal 50 to the output unit 163 as the position information of the user terminal 120.

If the position indicated by the position information of the user terminal 120 is encompassed by the geofence (YES at step S16), the output unit 163 generates sound localization information based on the position information, the direction information, and the altitude information of the user terminal 120 as well as the sound localization position information (step S24). The output unit 163 generates left-ear sound localization information for the left unit 40L and right-ear sound localization information for the right unit 40R, based on the position information of the user terminal 120, the direction information of the user terminal 120, the altitude information of the user terminal 120, and the sound localization position information. The output unit 163 outputs the sound localization information that includes the left-ear sound localization information and the right-ear sound localization information as well as the sound localization position information to the control unit 64.

As described above, even when the configuration of the second and third example embodiments is configured as in the fourth example embodiment, advantageous effects similar to those provided by the second and third example embodiments can be obtained. According to the fourth example embodiment, the server device 160 determines a sound localization position and generates sound localization information with further use of the altitude information of the user terminal 110 and of the user terminal 120. Accordingly, the information processing system 300 according to the fourth example embodiment can set a sound localization position closer to the position to which the user U1 wants to virtually install audio information, as compared to the second and third example embodiments.

### Other Example Embodiments

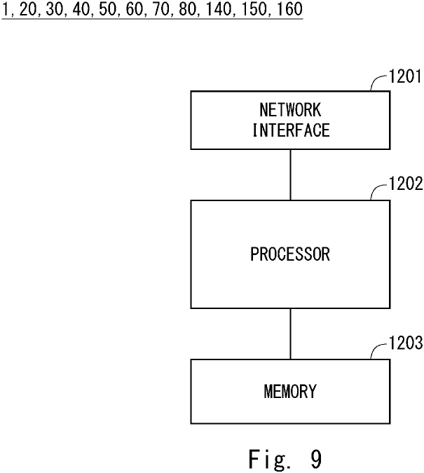

FIG. 9 illustrates a hardware configuration example of the information processing device 1, the communication terminals 20, 30, 40, 50, 70, 140, and 150, and the server devices 60, 80, and 600 (these are referred to below as the information processing device 1 and others) described according to the foregoing example embodiments. With reference to FIG. 9, the information processing device 1 and others each include a network interface 1201, a processor 1202, and a memory 1203. The network interface 1201 is used to communicate with another device included the information processing system.

The processor 1202 reads out software (computer program) from the memory 1203 and executes the software. Thus, the processor 1202 implements the processes of the information processing device 1 and others described with reference to the flowcharts according to the foregoing example embodiments. The processor 1202 may be, for example, a microprocessor, a micro processing unit (MPU), or a central processing unit (CPU). The processor 1202 may include a plurality of processors.

The memory 1203 is constituted by a combination of a volatile memory and a non-volatile memory. The memory 1203 may include a storage provided apart from the processor 1202. In this case, the processor 1202 may access the memory 1203 via an I/O interface (not illustrated).

In the example illustrated in FIG. 9, the memory 1203 is used to store a set of software modules. The processor 1202 can read out this set of software modules from the memory 1203 and execute this set of software modules. Thus, the processor 1202 can perform the processes of the information processing device 1 and others described according to the foregoing example embodiments.

As described with reference to FIG. 9, each of the processors in the information processing device 1 and others executes one or more programs including a set of instructions for causing a computer to execute the algorithms described with reference to the drawings.

In the foregoing examples, a program can be stored and provided to a computer by use of various types of non-transitory computer-readable media. Non-transitory computer-readable media include various types of tangible storage media. Examples of such non-transitory computer-readable media include a magnetic storage medium (e.g., flexible disk, magnetic tape, hard-disk drive) and a magneto-optical storage medium (e.g., magneto-optical disk). Additional examples of such non-transitory computer-readable media include a CD-ROM (read-only memory), a CD-R, and a CD-R/W. Yet additional examples of such non-transitory computer-readable media include a semiconductor memory. Examples of semiconductor memories include a mask ROM, a programmable ROM (PROM), an erasable PROM (EPROM), a flash ROM, or a random-access memory (RAM). A program may be supplied to a computer also by use of various types of transitory computer-readable media. Examples of such transitory computer-readable media include an electric signal, an optical signal, and an electromagnetic wave. A transitory computer-readable medium can supply a program to a computer via a wired communication line, such as an electric wire or an optical fiber, or via a wireless communication line.

It is to be noted that the present disclosure is not limited to the foregoing example embodiments, and modifications can be made, as appropriate, within the scope that does not depart from the technical spirit. The present disclosure may be implemented by combining the example embodiments, as appropriate.

A part or the whole of the foregoing example embodiments can also be expressed as in the following supplementary notes, which are not limiting.

### (Supplementary Note 1)

An information processing device comprising:
receiving means configured to receive, from a first user terminal, audio information, first position information of the first user terminal, first direction information of the first user terminal, and distance information of a distance from a position indicated by the first position information to an installation position at which the audio information is installed virtually; and
registering means configured to determine a sound localization position based on the first position information, the first direction information, and the distance information, and register the first position information, sound localization position information regarding the sound localization position, and the audio information into storage means with the first position information, the sound localization position information, and the audio information mapped to one another.

### (Supplementary Note 2)

The information processing device according to Supplementary Note 1, wherein the registering means is configured to generate region information that specifies a region with the position indicated by the first position information serving as a reference, and register the generated region information into the storage means with the region information mapped to the sound localization position information.

### (Supplementary Note 3)

The information processing device according to Supplementary Note 2, wherein
the receiving means is configured to receive, from a second user terminal, second position information of the second user terminal and second direction information of the second user terminal, and
the information processing device further comprises output means configured to generate sound localization information based on the sound localization position information, the second position information, and the second direction information, and output the audio information and the sound localization information, if a position indicated by the second position information is encompassed by the region.

### (Supplementary Note 4)

The information processing device according to Supplementary Note 3, wherein
the receiving means is further configured to receive first altitude information of the first user terminal and second altitude information of the second user terminal,
the registering means is configured to determine the sound localization position by further use of the first altitude information, and
the output means is configured to generate the sound localization information based on the sound localization position information, the second position information, the second direction information, and the second altitude information, if the position indicated by the second position information is encompassed by the region.

### (Supplementary Note 5)

The information processing device according to Supplementary Note 3 or 4, further comprising a control unit configured to execute a sound localization process on the audio information based on the audio information and the sound localization information, and transmit audio information subjected to the sound localization process to the second user terminal.

### (Supplementary Note 6)

The information processing device according to Supplementary Note 3 or 4, wherein the output means is configured to transmit the audio information and the sound localization information to the second user terminal.

### (Supplementary Note 7)

The information processing device according to any one of Supplementary Notes 2 to 6, wherein
the region information includes size information that specifies a size of the region, and
the registering means is configured to adjust the size information in accordance with the distance information.

### (Supplementary Note 8)

The information processing device according to Supplementary Note 7, wherein the registering means is configured to change the size information to reduce the size of the region, if a distance indicated by the distance information is no smaller than a predetermined value.

### (Supplementary Note 9)

The information processing device according to Supplementary Note 7 or 8, wherein the registering means is configured to, if a distance indicated by the distance information is smaller than a predetermined value, change the size information so that the size of the region becomes close to a size that is based on the distance.

### (Supplementary Note 10)

The information processing device according to any one of Supplementary Notes 2 to 9, wherein
the region information includes size information that specifies a size of the region, and
the registering means is configured to identify a size of an object located at the sound localization position, and adjust the size information based on the size of the object.

### (Supplementary Note 11)

The information processing device according to Supplementary Note 10, wherein the registering means is configured to change the size information so that the size of the region becomes a first size, if the size of the object is no smaller than a predetermined value.

### (Supplementary Note 12)

The information processing device according to Supplementary Note 11, wherein the registering means is configured to change the size information so that the size of the region becomes a second size smaller than the first size, if the size of the object is smaller than a predetermined value.

### (Supplementary Note 13)

The information processing device according to any one of Supplementary Notes 10 to 12, wherein
the receiving means is configured to receive, from the first user terminal, an image capturing an imaging region that includes the installation position, and
the registering means is configured to identify, based on the image, the size of the object located at the sound localization position.

### (Supplementary Note 14)

The information processing device according to any one of Supplementary Notes 10 to 12, wherein
the storage means is configured to store object information of a plurality of objects and object position information of the plurality of objects with the object information and the object position information mapped to each other, and
the registering means is configured to identify the size of the object based on object information mapped to, of the object position information, object position information that includes the first position information.

### (Supplementary Note 15)

A control method comprising:
receiving, from a first user terminal, audio information, first position information of the first user terminal, first direction information of the first user terminal, and distance information of a distance from a position indicated by the first position information to an installation position at which the audio information is installed virtually;
determining a sound localization position based on the first position information, the first direction information, and the distance information; and
registering the first position information, sound localization position information regarding the sound localization position, and the audio information into storage means with the first position information, the sound localization position information, and the audio information mapped to one another.

### (Supplementary Note 16)

A non-transitory computer-readable medium storing a control program that causes a computer to execute the processes of:
receiving, from a first user terminal, audio information, first position information of the first user terminal, first direction information of the first user terminal, and distance information of a distance from a position indicated by the first position information to an installation position at which the audio information is installed virtually;
determining a sound localization position based on the first position information, the first direction information, and the distance information; and
registering the first position information, sound localization position information regarding the sound localization position, and the audio information into storage means, with the first position information, the sound localization position information, and the audio information mapped to one another.

### (Supplementary Note 17)

An information processing system comprising:
a first user terminal; and
a server device configured to communicate with the first user terminal, wherein
the first user terminal is configured to acquire audio information, first position information of the first user terminal, first direction information of the first user terminal, and distance information of a distance from a position indicated by the first position information to an installation position at to which the audio information is installed virtually, and
the server device is configured to
   receive the audio information, the first position information, the first direction information, and the distance information from the first user terminal, and
   determine a sound localization position based on the first position information, the first direction information, and the distance information, and register the first position information, sound localization position information regarding the sound localization position, and the audio information into storage means with the first position information, the sound localization position information, and the audio information mapped to one another.

### (Supplementary Note 18)

The information processing system according to Supplementary Note 17, wherein the server device is configured to generate region information that specifies a region with the position indicated by the first position information serving as a reference, and register the generated region information into the storage means with the region information mapped to the sound localization position information.

### REFERENCE SIGNS LIST

1 INFORMATION PROCESSING DEVICE
2, 61, 161 RECEIVING UNIT
3, 62, 162 REGISTERING UNIT
20, 30, 40, 50, 70, 140, 150 COMMUNICATION TERMINAL
21 AUDIO INFORMATION ACQUIRING UNIT
22, 41 DIRECTION INFORMATION ACQUIRING UNIT
31, 51 POSITION INFORMATION ACQUIRING UNIT
32 DISTANCE INFORMATION ACQUIRING UNIT
42, 63, 81, 163 OUTPUT UNIT
60, 80, 160 SERVER DEVICE
64, 71 CONTROL UNIT
65 STORAGE UNIT
100, 200, 300 INFORMATION PROCESSING SYSTEM
110, 120 USER TERMINAL
141, 151 ALTITUDE INFORMATION ACQUIRING UNIT

What is claimed is:

1] An information processing device comprising:
at least one memory storing instructions, and
at least one processor configured to execute the instructions to: receive, from a first user terminal, audio information, first position information of the first user terminal, first direction information of the first user terminal, and distance information of a distance from a position indicated by the first position information to an installation position at which the audio information is installed virtually; and determine a sound localization position based on the first position information, the first direction information, and the distance information, and register the first position information, sound localization position information regarding the sound localization position, and the audio information with the first position information, the sound localization position information, and the audio information mapped to one another.

2] The information processing device according to claim 1, wherein the at least one processor is further configured to execute the instructions to generate region information that specifies a region with the position indicated by the first position information serving as a reference, and register the generated region information with the region information mapped to the sound localization position information.

3] The information processing device according to claim 2, wherein the at least one processor is further configured to execute the instructions to:
receive, from a second user terminal, second position information of the second user terminal and second direction information of the second user terminal, and
generate sound localization information based on the sound localization position information, the second position information, and the second direction information, and output the audio information and the sound localization information, if a position indicated by the second position information is encompassed by the region.

4] The information processing device according to claim 3, wherein the at least one processor is further configured to execute the instructions to:
receive first altitude information of the first user terminal and second altitude information of the second user terminal,
determine the sound localization position by further use of the first altitude information, and
generate the sound localization information based on the sound localization position information, the second position information, the second direction information, and the second altitude information, if the position indicated by the second position information is encompassed by the region.

5] The information processing device according to claim 3, wherein the at least one processor is further configured to execute the instructions to execute a sound localization process on the audio information based on the audio information and the sound localization information, and transmit audio information subjected to the sound localization process to the second user terminal.

6] The information processing device according to claim 3, the at least one processor is further configured to execute the instructions to transmit the audio information and the sound localization information to the second user terminal.

7] The information processing device according to claim 2, wherein
the region information includes size information that specifies a size of the region, and
the at least one processor is further configured to execute the instructions to the adjust the size information in accordance with the distance information.

8] The information processing device according to claim 7, wherein the at least one processor is further configured to execute the instructions to change the size information to reduce the size of the region, if a distance indicated by the distance information is no smaller than a predetermined value.

9] The information processing device according to claim 7, wherein the at least one processor is further configured to execute the instructions to, if a distance indicated by the distance information is smaller than a predetermined value, change the size information so that the size of the region becomes close to a size that is based on the distance.

10] The information processing device according to claim 2, wherein
the region information includes size information that specifies a size of the region, and
the at least one processor is further configured to execute the instructions to identify a size of an object located at the sound localization position, and adjust the size information based on the size of the object.

11] The information processing device according to claim 10, wherein the at least one processor is further configured to execute the instructions to change the size information so that the size of the region becomes a first size, if the size of the object is no smaller than a predetermined value.

12] The information processing device according to claim 11, wherein the at least one processor is further configured to execute the instructions to change the size information so that the size of the region becomes a second size smaller than the first size, if the size of the object is smaller than a predetermined value.

13] The information processing device according to claim 10, wherein the at least one processor is further configured to execute the instructions to:
receive, from the first user terminal, an image capturing an imaging region that includes the installation position, and
identify, based on the image, the size of the object located at the sound localization position.

14] The information processing device according to claim 10, wherein the at least one processor is further configured to execute the instructions to:
store object information of a plurality of objects and object position information of the plurality of objects with the object information and the object position information mapped to each other, and
identify the size of the object based on object information mapped to, of the object position information, object position information that includes the first position information.

15] A control method comprising:
receiving, from a first user terminal, audio information, first position information of the first user terminal, first direction information of the first user terminal, and distance information of a distance from a position indicated by the first position information to an installation position at which the audio information is installed virtually;
determining a sound localization position based on the first position information, the first direction information, and the distance information; and
registering the first position information, sound localization position information regarding the sound localization position, and the audio information with the first position information, the sound localization position information, and the audio information mapped to one another.

16] A non-transitory computer-readable medium storing a control program that causes a computer to execute the processes of:
receiving, from a first user terminal, audio information, first position information of the first user terminal, first direction information of the first user terminal, and distance information of a distance from a position indicated by the first position information to an installation position at which the audio information is installed virtually;
determining a sound localization position based on the first position information, the first direction information, and the distance information; and
registering the first position information, sound localization position information regarding the sound localization position, and the audio information, with the first position information, the sound localization position information, and the audio information mapped to one another.

17] An information processing system comprising:
a first user terminal; and
a server device configured to communicate with the first user terminal, wherein
the first user terminal is configured to acquire audio information, first position information of the first user terminal, first direction information of the first user terminal, and distance information of a distance from a position indicated by the first position information to an installation position at to which the audio information is installed virtually, and
the server device is configured to
receive the audio information, the first position information, the first direction information, and the distance information from the first user terminal, and
determine a sound localization position based on the first position information, the first direction information, and the distance information, and register the first position information, sound localization position information regarding the sound localization position, and the audio information with the first position information, the sound localization position information, and the audio information mapped to one another.

18] The information processing system according to claim 17, wherein the server device is configured to generate region information that specifies a region with the position indicated by the first position information serving as a reference, and register the generated region information with the region information mapped to the sound localization position information.
